(19) United States
(12) Patent Application Publication
(10) Pub. No.: US 2016/0244159 A1
(43) Pub. Date: Aug. 25, 2016

(54) Controlled Take-Off And Flight System Using Thrust Differentials

(71) Applicant: Transition Robotics, Inc., Santa Cruz, CA (US)

(72) Inventor: JoeBen Bevirt, Santa Cruz, CA (US)

(21) Appl. No.: 14/862,134

(22) Filed: Sep. 22, 2015

Related U.S. Application Data
(63) Continuation of application No. 13/433,276, filed on Mar. 28, 2012, now abandoned.

(51) Int. Cl. B64C 29/02; B64C 39/02

(52) U.S. Cl. CPC B64C 29/02; B64C 39/024; B64C 2201/02; B64C 2201/108; B64C 2201/165

(57) ABSTRACT

A manned/unmanned aerial vehicle adapted for vertical takeoff and landing using the same set of engines for takeoff and landing as well as for forward flight. An aerial vehicle which is adapted to takeoff with the wings in a vertical as opposed to horizontal flight attitude which takes off in this vertical attitude and then transitions to a horizontal flight path. An aerial vehicle which controls the attitude of the vehicle during takeoff and landing by alternating the thrust of engines, which are separated in least two dimensions relative to the horizontal during takeoff. An aerial vehicle which uses a rotating platform of engines in fixed relationship to each other and which rotates relative to the wings of the vehicle for takeoff and landing.

### CROSS-REFERENCE TO RELATED APPLICATIONS

This application is a continuation of U.S. patent application Ser. No. 13/433,276, to Sinha et al., filed Mar. 28, 2012, which is a continuation in part of U.S. patent application Ser. No. 12/566,667, to Bevirt, filed Sep. 25, 2009.

### BACKGROUND

1. Field of the Invention

This invention relates to powered flight, and more specifically to a take-off and flight control method using thrust differentials.

2. Description of Related Art

There are generally three types of vertical takeoff and landing (VTOL) configurations: wing type configurations having a fuselage with rotatable wings and engines or fixed wings with vectored thrust engines for vertical and horizontal translational flight; helicopter type configuration having a fuselage with a rotor mounted above which provides lift and thrust; and ducted type configurations having a fuselage with a ducted rotor system which provides translational flight as well as vertical takeoff and landing capabilities.

VTOL capability may be sought after in manned vehicle applications, such as otherwise traditional aircraft. An unmanned aerial vehicle (UAV) is a powered, heavier than air, aerial vehicle that does not carry a human operator, or pilot, and which uses aerodynamic forces to provide vehicle lift, can fly autonomously, or can be piloted remotely. Because UAVs are unmanned, and cost substantially less than conventional manned aircraft, they are able to be utilized in a significant number of operating environments.

UAVs provide tremendous utility in numerous applications. For example, UAVs are commonly used by the military to provide mobile aerial observation platforms that allow for observation of ground sites at reduced risk to ground personnel. The typical UAV that is used today has a fuselage with wings extending outward, control surfaces mounted on the wings, a rudder, and an engine that propels the UAV in forward flight. Such UAVs can fly autonomously and/or can be controlled by an operator from a remote location.

A typical UAV takes off and lands like an ordinary airplane. Runways may not always be available, or their use may be impractical. It is often desirable to use a UAV in a confined area for takeoff and landing, which leads to a desire for a craft that can achieve VTOL.

### SUMMARY

A manned/unmanned aerial vehicle adapted for vertical takeoff and landing using the same set of engines for takeoff and landing as well as for forward flight. An aerial vehicle which is adapted to takeoff with the wings in a vertical as opposed to horizontal flight attitude which takes off in this vertical attitude and then transitions to a horizontal flight path. An aerial vehicle which controls the attitude of the vehicle during takeoff and landing by alternating the thrust of engines, which are separated in at least two dimensions relative to the horizontal during takeoff, and which may also control regular flight in some aspects by the use of differential thrust of the engines. An aerial vehicle which uses a rotating platform of engines in fixed relationship to each other and which rotates relative to the wings of the vehicle for takeoff and landing.

### BRIEF DESCRIPTION OF THE DRAWINGS

FIG. 1 is an illustration of an unmanned aerial vehicle according to some embodiments of the present invention.

FIG. 2 is a sketch illustrating an airplane coordinate system.

FIG. 3 is an end view of an unmanned aerial vehicle prior to takeoff according to some embodiments of the present invention.

FIG. 4 is a top view of an unmanned aerial vehicle prior to takeoff according to some embodiments of the present invention.

FIG. 5 is an illustration of an aerial vehicle during vertical takeoff and transition to horizontal flight according to some embodiments of the present invention.

FIG. 6 is a perspective view of an aerial vehicle according to some embodiments of the present invention.

FIG. 7 is a side view of an aerial vehicle on the ground according to some embodiments of the present invention.

FIG. 8 is a perspective view of a flying aerial vehicle according to some embodiments of the present invention.

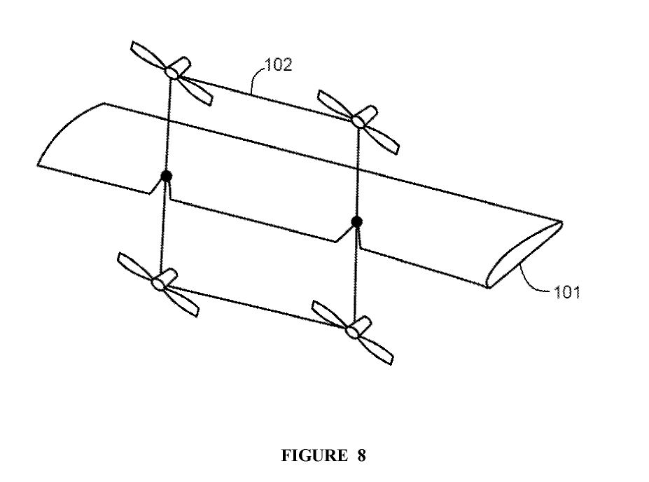

FIG. 9 is an illustration of an aerial vehicle according to some embodiments of the present invention.

FIG. 10 is an illustration of an aerial vehicle according to some embodiments of the present invention.

### DETAILED DESCRIPTION

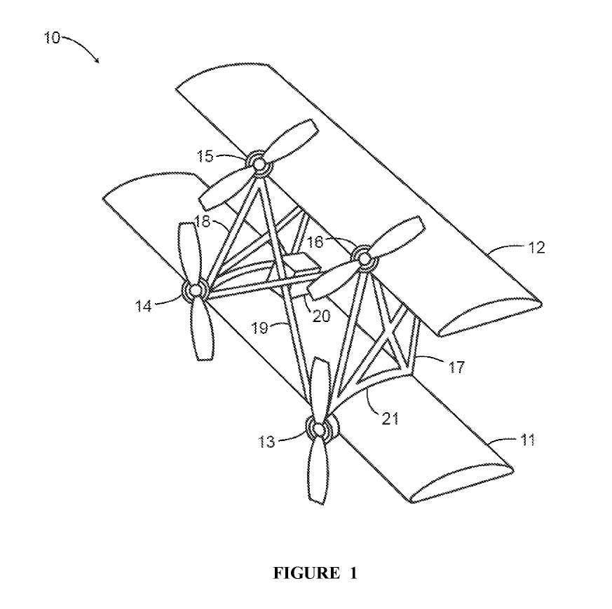

In some embodiments of the present invention, as seen in FIG. 1, an aerial vehicle 10 is seen with a first wing 11 and a second wing 12 stacked together in a biplane formation. Two thrust producing elements 13, 14 are mounted along the first wing 11, and two thrust producing elements 15, 16 are mounted along the second wing 12. A frame structure 21 is used to support loading and to position the wings 11, 12 relative to each other. The frame structure may consist of a combination of vertical elements 17, 18 and cross elements 19. The thrust producing elements 13, 14, 15, 16 are fixedly mounted to the wings 11, 12. The thrust producing elements 13, 14, 15, 16 may be electric motors with propellers in some embodiments.

In some embodiments, an electronics package 20 may be mounted within the frame structure. The electronics package may include control electronics for the aerial vehicle which may further include attitude sensors as well as motor control electronics. In some embodiments, the thrust producing elements 13, 14, 15, 16 are electric motors. Batteries to power the electric motors may be mounted within the electronics package 20, at other positions within the frame structure 21, or at other locations within the aerial vehicle 10.

Although not illustrated in FIG. 1, in some embodiments the aerial vehicle 10 may have control surfaces such as ailerons, rudders, elevators, and/or other control surfaces. In some embodiments, the aerial vehicle may be adapted to be a manned aerial vehicle. In some embodiments, the aerial vehicle 10 may have ailerons on one or more of its wings which are adapted for roll control. The vehicle may be adapted to turn using a simultaneous roll and pitch up, which is affected by the ailerons with regard to roll, and by differentially throttling the engines with regard to pitch. Namely, the thrust producing elements 15, 16 of the upper wing 12 may be throttled down relative to the engines 13, 14 of the lower wing 11 to achieve an upward change in pitch used in conjunction with the roll of the vehicle to turn the vehicle.

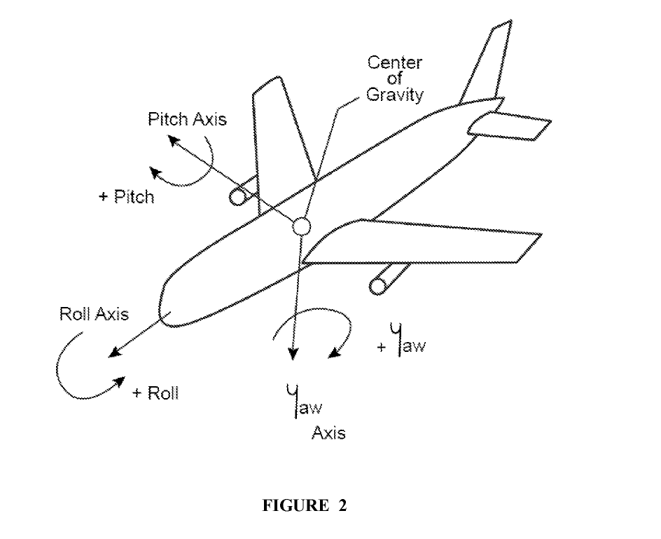

FIG. 2 illustrates a reference frame fixed relative to the aircraft which is used in the description of axes herein. In horizontal, nominal flight, the direction in which the aerial vehicle flies is referred to as the nominal flight direction. In a biplane configuration, one of the wings, for example the upper wing, may lead the other wing slightly as a stagger which is part of the vehicle design. Thus, when constructing a geometric plane across the leading edges of the two wings, and then constructing a perpendicular line forward from that plane, the constructed line may not point in the flight direction due to the stagger of the wings. The nominal flight direction is an axis forward from the vehicle representing the direction in which the vehicle is flying when in horizontal type flight.

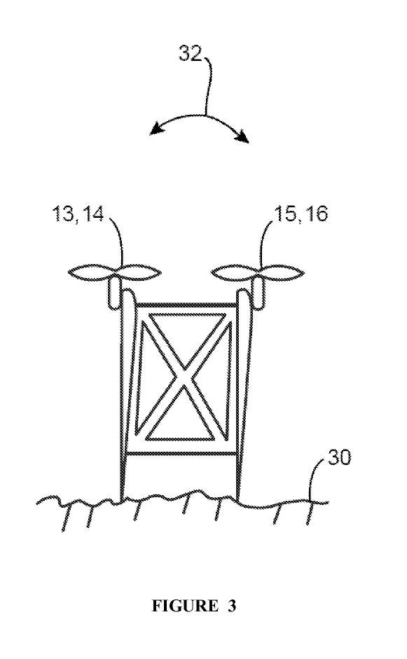

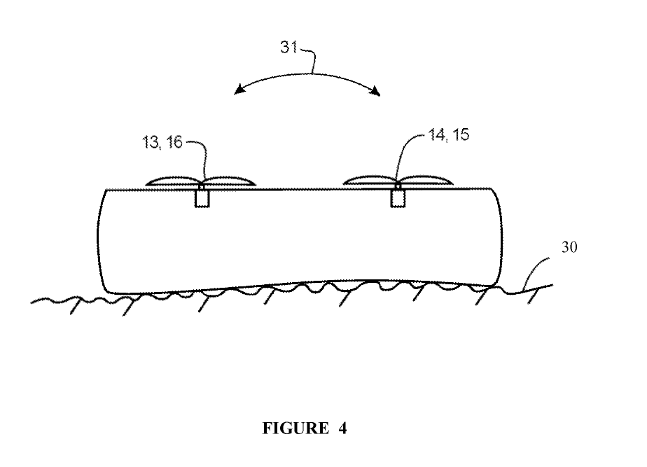

FIG. 3 is an illustration of a side view of an aerial vehicle 10 laying on the ground 30 with the thrust producing elements 13, 14, 15, 16 facing skyward. FIG. 4 is an illustration of a top view of an aerial vehicle 10 laying on the ground 30 with the thrust producing elements 13, 14, 15, 16 facing skyward. Although illustrated as the rear of the wings 11, 12 being on the ground 30, there may be structure on the aerial vehicle, attached to the wings or other portions of the aerial vehicle, adapted to allow the mass of the aerial vehicle to be supported in this position. In some embodiments, the vehicle may be adapted to rest facing skywards in water, either using the buoyancy of the wings or through some other method.

Using the aircraft based coordinate system as illustrated in FIG. 2, the heading change 32 illustrated in FIG. 3 would be a change of pitch. Using the aircraft based coordinate system as illustrated in FIG. 3, the heading change 31 illustrated in FIG. 4 would be a change in yaw. In a vertical takeoff scenario, the thrust producing elements 13, 14, 15, 16 are varied in power output in order to either change, or maintain, pitch and yaw. For example, to effect a pitch change (in aircraft based coordinates), the relative power output of the thrust producing elements 13, 14 associated with the lower wing 11 can be varied relative to the power output of the thrust producing elements 15, 16 associated with the upper wing 12. To effect a yaw change, the relative power output of the left side thrust producing elements 13, 16 can be varied relative to the power output of the right side thrust producing elements 14, 15. In this way, the aerial vehicle can be raised from the ground in a vertical takeoff scenario while maintaining control of pitch and yaw.

In some embodiments, the aerial vehicle may use a sensor package adapted to provide real time attitude information to a control system which is adapted to perform a vertical takeoff while maintaining the ground position of the aerial vehicle. The control system may be autonomous in keeping the ground attitude while an operator commands an altitude raise while in takeoff mode. With the aerial vehicle adapted to take off from a position wherein the leading edges of the wings and the engines face skywards, no relative motion of the engines and the wings is necessary to achieve vertical take off and landing.

The spacing of the thrust producing elements in two dimensions as viewed from above when the aerial vehicle is on the ground ready for takeoff allows the engine power differentials to control the aircraft in the pitch and yaw axes. Although four thrust producing elements are illustrated here, the two dimensional spacing needed to effect two dimensional control could be achieved with as few as three engines.

Although the control of pitch and yaw has been discussed, in some embodiments the roll axis may also be controlled. In some embodiments, the thrust producing elements may be engines which rotate in different directions. The powering up and down of engines which are rotating in opposite directions along the roll axis will create torque along the roll axis, which allows for control of the aircraft along that axis. In some embodiments, the roll control during takeoff and landing may be controlled using ailerons.

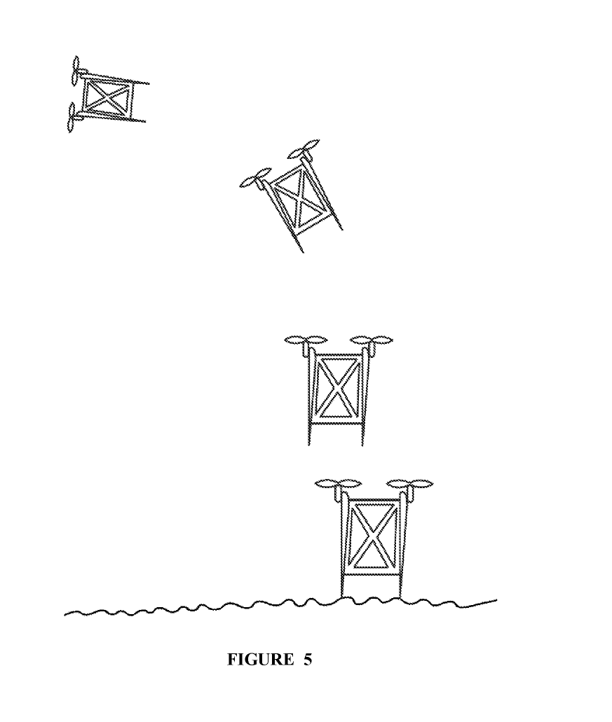

FIG. 5 illustrates the transition from vertical takeoff to horizontal flight according to some embodiments of the present invention. As seen, the aerial vehicle first engages in vertical takeoff while maintaining attitude control using an onboard sensor package and by varying the power output of the engines to maintain attitude in a desired range, and may also use the ailerons for control in a third axis. As the aerial vehicle is raised to a desired altitude, the transition to horizontal flight begins. With the use of differential power output control of the engines, the aerial vehicle is pitched forward, which alters the wings from their skyward facing position to a more horizontal, normal flying position. This forward pitching of the aerial vehicle also causes the vehicle to begin to accelerate forward horizontally. With the increase in horizontal velocity coupled with the wing airfoils attitude change to a more horizontal position, lift is generated from the wing airfoils. Thus, as the engines are transitioned to a more horizontal position and their vertical thrust is reduced, lift is begun to be generated from the wing airfoils and the altitude of the aerial vehicle is maintained using the lift of the wings. In this fashion, the aerial vehicle is able to achieve vertical takeoff and transition to horizontal flight without relative motion of the engines to the wings, and using differential control of the power of the engines to achieve some, if not all, of the attitude changes for this maneuver. When landing the craft, these steps as described above are reversed.

The control system adapted for control of pitch and yaw during takeoff using differential control of the thrust elements, which may be electric motors with propellers in some embodiments, is also adapted to be used during traditional, more horizontal flight. Although the aerial vehicle may have rudders and elevators in some embodiments, the aerial vehicle and its control system are adapted to use differential control of the thrust elements to vary pitch and yaw, and in some embodiments, to control roll as well.

In an example of the aerial vehicle 10 according to some embodiments of the present invention, the upper and lower wings have a span of 36 inches and a chord length of 6 inches. The two wings are separated by a 14 inch vertical spacing. The horizontal spacing between the engine propeller axes is 20 inches. The engines are 12V 100 W electric motors with propellers having a 12 inch diameter.

In this example of the aerial vehicle 10, the aerial vehicle may be unmanned and controlled by a ground controller using a remote control unit. The ground controller may be able to control pitch, roll, and yaw, and also composite throttle. The pitch, roll, and yaw of the aerial vehicle are controlled relative to a fixed earth axis.

When the ground controller gives a pitch command, the onboard control system then executes a pitch change using a combination of engine thrust differentiation, and also through the use of the ailerons on both sides of the wing in common mode. The pitch change will be executed primarily or fully by differential throttling of the upper and lower engines. The pitch angle of the aerial vehicle will remain at that commanded pitch angle until a new command is received from the ground controller.

When the ground controller gives a roll command, the onboard control system then executes a roll of the aerial vehicle using a combination of aileron control and differential thrusting of counter-rotating engines on the aerial vehicle. The roll angle of the aerial vehicle will remain at that commanded roll angle until a new command is received from the ground controller.

When the ground controller gives a yaw command, the onboard control system then executes a yaw change of the aerial vehicle using engine thrust differentiation. The yaw change will be executed by differential throttling of the upper and lower engines. The yaw angle of the aerial vehicle will remain at that commanded yaw angle until a new command is received from the ground controller.

The speed of the aerial vehicle, and also the rate at which it rises or lowers during vertical takeoff and landing, can be controlled by a common mode throttle command from the ground control. As the relative output of the engines is varied somewhat by the control system as it maintains attitude, it is the overall average output that is commanded by the ground controller.

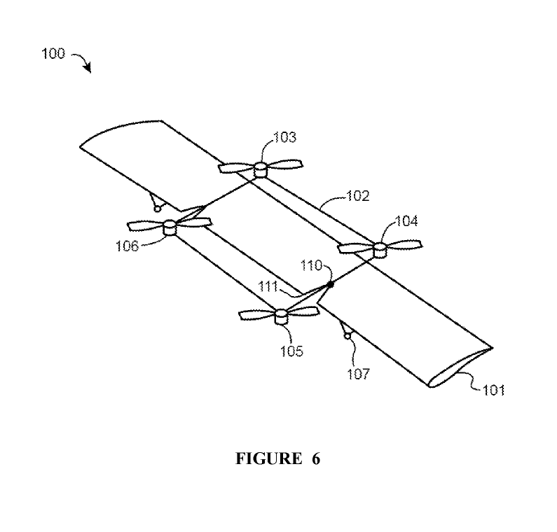

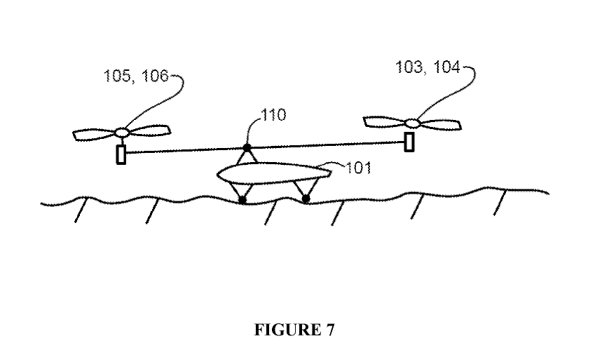

In some embodiments of the present invention, as seen in FIGS. 6 and 7, an aerial vehicle 100 has four thrust producing elements 103, 104, 105, 106 mounted on a frame 102. The aerial vehicle 100 has a wing 101 which may have landing gear 107 adapted to support the aerial vehicle 100 while on the ground. The frame 102 may be pivotally attached to wing 101 with a mechanism adapted to pivot it in one axis in an approximately 90 degree range. In some embodiments, as in the case of a manned vehicle, the thrust producing elements may be pivoted via a command given from the pilot's compartment. The command may be an electronic command or with the use of a lever of other mechanical input device. In some embodiments, the pivoting may be passive, using a damper to dampen the relative motion of the wing or wings to the engines. The pivot point in such an embodiment may be above the center of mass of the non-rotating portion of the vehicle.

In some embodiments, the aerial vehicle 100 may use a sensor package adapted to provide real time attitude information to a control system which is adapted to perform a vertical takeoff while maintaining the ground position of the aerial vehicle. The control system may be autonomous in keeping the ground attitude while an operator commands an altitude raise while in takeoff mode. With the aerial vehicle adapted to take off from a position wherein the leading edges of the wings face horizontally and the thrust producing elements face skywards, the frame 102 will rotate approximately 90 degrees after takeoff relative to the wing or wings.

The spacing of the thrust producing elements in two dimensions as viewed from above when the aerial vehicle is on the ground ready for takeoff allows the engine power differentials to control the aircraft in the pitch and yaw axes. Although four thrust producing elements are illustrated here, the two dimensional spacing needed to effect two dimensional control could be achieved with as few as three thrust producing elements. This type of control may be used not just for takeoff and landing but also for regular flight.

The aerial vehicle 100 first engages in vertical takeoff while maintaining attitude control using an onboard sensor package and by varying the power output of the engines to maintain attitude in a desired range. As the aerial vehicle is raised to a desired altitude, the transition to horizontal flight begins. With the use of differential power output control of the engines and/or the use of a pivot mechanism between the frame 102 and the wing 101, the frame 102 is pitched forward, which causes the vehicle to begin to accelerate forward horizontally. With the increase in horizontal velocity, lift is generated from the wing airfoils. Thus, as the engines are transitioned to a more horizontal position and their vertical thrust is reduced, lift is begun to be generated from the wing airfoils and the altitude of the aerial vehicle is maintained using the lift of the wings. In this fashion, the aerial vehicle is able to achieve vertical takeoff and transition to horizontal flight, and using differential control of the power of the engines to achieve some, if not all, of the attitude changes for this maneuver. When landing the craft, these steps as described above are reversed.

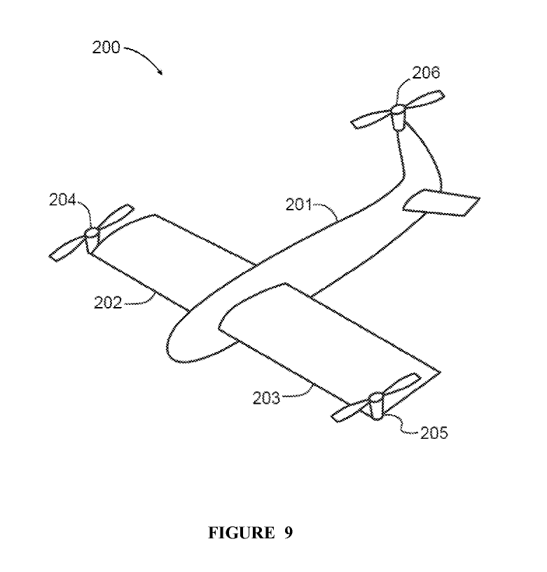

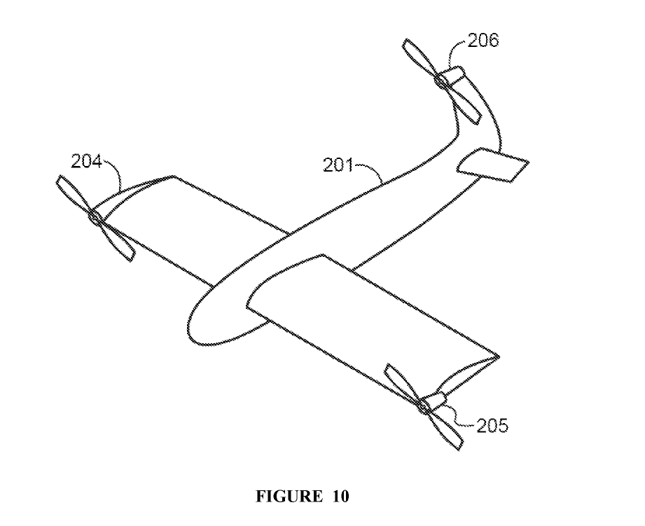

In some embodiments of the present invention, as seen in FIGS. 9 and 10, an aerial vehicle 200 is seen with three thrust producing elements 204, 205, 206. Two of the thrust producing elements 204, 205 are located at the ends of the wings 202, 203. The main body 201 has a raised tail structure with a third engine 206. The thrust producing elements are rotatable from a position wherein their thrust output is primarily downward to a position which is primarily rearward. This allows the engines to be used both for vertical takeoff and landing as well as in regular flight. The thrust producing elements may be motors with propellers in some embodiments.

As seen in FIG. 9, the three thrust producing elements are separated in two axis when viewed from above when the engines are rotated such that their thrust is downward. This spacing allows the attitude control of the aerial vehicle 200 to be controlled using thrust differential between the different thrust producing elements during vertical takeoff and landing. Also, as seen in FIG. 10, the three thrust producing elements are separated in two axis when viewed from the front when the engines are rotated such that their thrust is rearward. This spacing allows the attitude control of the aerial vehicle 200 to be controlled using thrust differential between the different thrust producing elements during regular flight.

An aerial vehicle 200 according to some embodiments of the present invention thus allows for attitude control of the vehicle during VTOL and regular using the same control system parameters.

As evident from the above description, a wide variety of embodiments may be configured from the description given herein and additional advantages and modifications will readily occur to those skilled in the art. The invention in its broader aspects is, therefore, not limited to the specific details and illustrative examples shown and described. Accordingly, departures from such details may be made without departing from the spirit or scope of the applicant's general invention.

What is claimed is:

1. An aerial vehicle adapted for vertical takeoff and horizontal flight, said aerial vehicle comprising:
three or more thrust producing elements differentially spaced relative to the thrust direction of said thrust producing elements while said vehicle body is in vertical or horizontal flight;
one or more wings; and
a flight control system, said flight control system adapted control the attitude of said aerial vehicle while taking off vertically by varying the thrust of the three or more thrust producing elements, said flight control system adapted to control the attitude of said aerial vehicle while in horizontal flight by varying the thrust of the three or more thrust producing elements.

2. The aerial vehicle of claim 1 wherein said three or more thrust producing elements are mounted in a fixed non-rotatable relationship to said one or more wings.

3. The aerial vehicle of claim 2 wherein said aerial vehicle comprises two wings in a biplane formation, and wherein two thrust producing elements are mounted on each of said wings, and wherein said vehicle is adapted for vertical takeoff with its wing leading edges facing skyward.

4. The aerial vehicle of claim 1 wherein said three are more thrust producing elements are mounted in fixed relationship to each other on a frame which is rotatable relative to the one or more wings.

5. The aerial vehicle of claim 1 wherein said thrust producing elements are engines which rotate, and wherein one or more of the three or more engines rotates counter to the rotation of other of the three or more engines, and wherein said vehicle is adapted to control roll at least in part by varying the power of counter-rotating engines.

6. An aerial vehicle adapted for vertical take-off and horizontal flight, said aerial vehicle comprising:
an upper wing;
a lower wing;
a body structure supporting said upper wing and said lower wing;
a first right motor assembly attached to said upper wing;
a second right motor assembly attached to said lower wing;
a first left motor assembly attached to said upper wing;
a second left motor assembly attached to said lower wing; and
a flight control system, said flight control system adapted control the attitude of said aerial vehicle while taking off vertically by varying the thrust of the motors, said flight control system adapted to control the attitude of said aerial vehicle while in horizontal flight by varying the thrust of the motors.

7. The aerial vehicle of claim 6 wherein each of said motor assemblies comprises:
an electric motor; and
a propeller.

8. An aerial vehicle adapted for vertical take-off and horizontal flight, said aerial vehicle comprising:
an upper wing;
a lower wing;
a body structure supporting said upper wing and said lower wing;
a first right motor assembly attached to said body structure on the right side of said body structure and adjacent to said upper wing;
a second right motor assembly attached to said body structure on the right side of said body structure and adjacent to said lower wing;
a first left side motor assembly attached to said body structure on the left side of said body structure and adjacent to said upper wing;
a second left side motor assembly attached to said body structure on the left side of said body structure and adjacent to said lower wing; and
a flight control system, said flight control system adapted to control the attitude of said aerial vehicle while taking off vertically by varying the thrust of the motors, said flight control system adapted to control the attitude of said aerial vehicle while in horizontal flight by varying the thrust of the motors.

9. The aerial vehicle of claim 8 wherein each of said motor assemblies comprises:
an electric motor; and
a propeller.
